(19) United States
(12) Patent Application Publication
(10) Pub. No.: US 2024/0249655 A1
(43) Pub. Date: Jul. 25, 2024

(54) THIN-FILM ELECTROLUMINESCENT DISPLAY AND METHOD FOR DRIVING A THIN-FILM ELECTROLUMINESCENT DISPLAY

(71) Applicant: Lumineq Oy, Espoo (FI)

(72) Inventor: Mika Sirkiä, Espoo (FI)

(21) Appl. No.: 18/564,387

(22) PCT Filed: May 17, 2022
(86) PCT No.: PCT/FI2022/050328

§ 371 Date: Nov. 27, 2023

(30) Foreign Application Priority Data
May 27, 2021 (FI) 20215625

(51) Int. Cl. G09G 3/14; H05B 33/02; H05B 33/26

(52) U.S. Cl. CPC G09G 3/14; H05B 33/02; H05B 33/26; G09G 2320/02

(57) ABSTRACT

A thin-film electroluminescent display is disclosed, comprising a thin-film display element. The thin-film display element comprises a common layer comprising common electrodes, a segment layer comprising segment electrodes, and a luminescent layer arranged to produce visible light when a voltage over a threshold voltage is arranged between the common electrodes and the overlapping segment electrodes. The display comprises further a common driver comprising common connections, each of the common connections connected to one of the common electrodes. Each of the common connections comprises a voltage limiter arranged to limit voltage of the one or more undriven common electrodes to a voltage which may vary within a limited voltage range. A related method is also disclosed.

### CROSS-REFERENCE TO RELATED APPLICATIONS

This application is a national phase entry under Chapter I of the Patent Cooperation Treaty of International Patent Application No. PCT/FI2022/050328 (filed 17 May 2022), which claims priority to Finnish Patent Application No. 20215625 (filed 27 May 2021). The entire disclosures of these applications are incorporated herein by reference.

### FIELD OF THE INVENTION

The present invention relates to a thin-film electroluminescent display (“TFEL”) and more particularly to a thin-film electroluminescent display. The present invention relates also to a method for driving a thin-film electroluminescent display.

### BACKGROUND OF THE INVENTION

In the prior art, thin-film electroluminescent displays are well known and robust emissive display devices that can withstand severe environmental factors like high and low temperatures, high pressures, shocks and vibrations. Both transparent and non-transparent thin-film electroluminescent displays (TFELs) are known. Transparent TFELs have excellent transparency characteristics, reaching photopic transmission of over 70%. Basic technology of TFELs dates back to 1980s, but important improvements are still being made, and many new applications for TFELs are found, for example in-glass laminated and optical applications.

From the standpoint of addressing a certain picture element to produce light (be “on”) or to remain dark (be “off”) during the TFEL's operation, two main categories exist: a segment TFEL display where the information is presented by turning on and off segments representing fixed symbols or pictograms (for example an arrow pointing up), and a matrix TFEL display where the information is generated by turning on and off pixels that, when combined, form symbols like letters, numbers and other pictograms to yield information. In general, segment displays can produce a brighter light output than their matrix counterparts, but naturally can only produce information which is available from their fixed set of symbols laid out on the display panel during the manufacturing of the display.

One of the problems associated with the prior art segment TFELs is that the routing of the traces that interconnect a segment, or more specifically the light producing segment electrode to the connection area at the edge of the display element (also called display panel) becomes very challenging as it is difficult or even impossible to arrange the traces of the segment electrodes into more than one different layer of the display panel. Naturally, the traces cannot cross on one layer, or otherwise a short circuit and erroneous display light production would occur. In matrix TFEL displays (that are mostly of the so-called passive matrix type), this problem is solved by splitting the common electrode on the opposite side of the luminescent layer to distinct rows that can be addressed separately with common driving voltages. This simplifies the design of the layout of the segment electrodes (that are usually called “column electrodes” in matrix TFELs) and their traces to the connection area considerably, at the expense of more complicated driving electronics. In general, common electrodes are called “common” because they may serve a group of segment electrodes overlapping the common electrodes.

However, it is to be noted that in the matrix TFELs where one row (that is, one common electrode) is driven at a time, and the other rows remain undriven and are set a “floating” or “high impedance” state with no distinct voltage driven to them, all the segments are pixels (picture elements), and thus have essentially the same or even identical area and shape governed by the resolution and size of the TFEL display.

If the size of segment electrodes can vary freely, and if the TFEL comprises at least two separate common electrodes driven with separate common driving voltage signals at different intervals of time (that is, like in a matrix display), a current path comprising a series connection of at least one segment-common electrode capacitance and one common-segment electrode capacitance is created from one driving node of the segment driver to another driving node, possibly having, between the said two nodes, a voltage difference of a driving voltage of the TFEL display. Owing to the elementary division of voltages over capacitances in series, for a small enough segment electrode, the voltage between the small segment electrode and the common electrode can exceed the threshold voltage of light production of the TFEL luminescent layer. Thus, as a problem in prior art, erroneous light output from a small segment electrode overlapping an undriven common electrode in a floating state can occur.

One obvious solution is to drive actively the other “undriven” common electrodes (whose overlapping segment electrodes are to remain dark) to a voltage that, relative to the segment electrode voltages, does not create a common-segment voltage exceeding the threshold voltage. However, creating many distinct voltage levels in a TFEL requires more expensive transformers and dedicated rectifiers, requires more control operations, and consumes more power. This is especially challenging if the TFEL has a small overall size and should be battery-operated, like in a case of a see-through display in an optical device like an aim-scope or telescope.

### BRIEF DESCRIPTION OF THE INVENTION

An object of the present invention is to provide a TFEL display with more than one separate common electrodes that overcomes or at least alleviates the problems of the prior art mentioned above.

The objects of the invention are achieved by a thin-film electroluminescent display characterized by what is stated in the independent claim 1. The objects of the invention are further achieved by a method for driving a thin-film electroluminescent display characterized by what is stated in the independent claim 13.

The preferred embodiments of the invention are disclosed in the dependent claims.

As an aspect of the present invention, a thin-film electroluminescent display is disclosed. The thin-film electroluminescent display comprises a high voltage node supplying a driving voltage (VH), a low voltage node supplying a low voltage (VL), a thin-film display element extending substantially along abase plane defining a lateral extension of the thin-film display element, the thin-film display element comprising a common layer comprising common electrodes, a segment layer comprising segment electrodes, the segment electrodes arranged at least partially to laterally overlap with the common electrodes. The thin-film display element comprises also a luminescent layer arranged between the common layer and the segment layer, the luminescent layer arranged to produce visible light when a voltage difference exceeding a threshold voltage (VT) is arranged between the common electrodes and the overlapping segment electrodes. The thin-film electroluminescent display comprises also a segment driver arranged to feed segment driving voltage signals to the segment electrodes during a driving period, a common driver comprising common connections, each of the common connections connected to one of the common electrodes, the common driver arranged to feed a common driving voltage signal sequentially to a driven common electrode during the driving period through one of the common connections, the driven common electrode being one of the common electrodes, and set one or more undriven common electrodes and the common connections connected to the one or more undriven common electrodes to a high impedance state during the driving period, the one or more undriven common electrodes being the common electrodes other than the driven common electrode. Each of the common connections comprises a voltage limiter arranged to limit voltage of the one or more undriven common electrodes caused by the segment driving voltage signals during the driving period to a voltage which may vary within a limited voltage range. Advantage of the voltage limiters is that erroneous light production due to current paths created by the high impedance, undriven common electrodes is hindered.

In an embodiment of the thin-film electroluminescent display, the limited voltage range has an upper bound which is the threshold voltage, and a lower bound which is the driving voltage less the threshold voltage. These upper and lower bounds are advantageous to guarantee that no erroneous light production occurs.

In an embodiment of the thin-film electroluminescent display, the voltage limiter comprises a high voltage side limiter connected between the high voltage node and the common connection, and a low voltage side limiter connected between the low voltage node and the common connection. Providing two separate voltage limiters makes it straightforward to limit both upper and lower bounds of the limited voltage range with a simple circuit design.

In an embodiment of the thin-film electroluminescent display, the high voltage side limiter comprises a series connection of a high voltage side zener diode and a high voltage side switching circuit, the high voltage size zener diode having a zener voltage which is smaller or equal to the threshold voltage and larger or equal to the driving voltage less the threshold voltage. This is a reliable and cost-effective solution for the realization of the high side voltage limiter.

In an embodiment of the thin-film electroluminescent display, the common driver is arranged to control the high voltage side switching circuit connected to the one or more undriven common electrodes to a conducting state during the driving period. This is one realisation to arrange and enable the voltage limiting to the undriven common electrodes during the driving period.

In an embodiment of the thin-film electroluminescent display, the high voltage side switching circuit comprises a P-channel field effect transistor having a gate node connected to a control node of the high voltage side switching circuit. This is a reliable and cost-effective solution for the realization of the high voltage side switching circuit.

In an embodiment of the thin-film electroluminescent display, the high voltage side switching circuit comprises an N-channel field effect transistor having a gate node connected to a gate driver unit, and the gate driver unit is connected to a control node of the high voltage side switching circuit. This is a reliable and cost-effective solution for the realization of the high voltage side switching circuit with an N-channel field effect transistor, and with the gate driver unit, high enough gate-source voltage levels to the gate of the N-channel field effect transistor may be arranged to achieve a correct switching operation.

In an embodiment of the thin-film electroluminescent display, the low voltage side limiter comprises a series connection of a low voltage side zener diode and a low voltage side switching circuit, the low voltage size zener diode having a zener voltage which is smaller or equal to the threshold voltage and larger or equal to the driving voltage less the threshold voltage. This is a reliable and cost-effective solution for the realization of the low side voltage limiter.

In an embodiment of the thin-film electroluminescent display, the common driver is arranged to control the low voltage side switching circuit connected to the one or more undriven common electrodes to a conducting state during the driving period. This is one realisation to arrange and enable the voltage limiting to the undriven common electrodes during the driving period.

In an embodiment of the thin-film electroluminescent display, the low voltage side switching circuit comprises an N-channel field effect transistor having a gate node connected to a control node of the low voltage side switching circuit. This is a reliable and cost-effective solution for the realization of the low voltage side switching circuit.

In an embodiment of the thin-film electroluminescent display, at least one of the segment electrodes has a different area than the other segment electrodes. In other words, the information conveyed by the size and shape of the segment electrodes are no longer limited by size restrictions, especially when the thin-film electroluminescent display comprises at least two separate common electrodes that are fed separately with common driving voltage signals separated in time.

In an embodiment of the thin-film electroluminescent display, one of the segment electrodes overlapping one common electrode has an area of overlap which is different than the areas of overlaps of the one or more other segment electrodes overlapping the same one common electrode. In other words, the information conveyed by the size and shape of the segment electrodes and their areas of overlap with the common electrodes are no longer limited by size restrictions. This is especially when the thin-film electroluminescent display comprises at least two separate common electrodes that are fed separately with common driving voltage signals separated in time.

In an embodiment of the thin-film electroluminescent display, one of the segment electrodes overlapping one common electrode has an area of overlap which is less than a fraction F of the combined area of overlaps of the one or more other segment electrodes overlapping the same one common electrode such that F is equal to a value of VH/VT−1, where VH is the driving voltage, and VT is the threshold voltage. The smallest segment electrode or more specifically, the area of smallest overlap of a segment and common electrode is the most prone for erroneous light production, and the fraction F is the limit under which, in terms of the smallest segment electrode-common electrode overlapping area, erroneous light production will occur without the voltage limitation of the common electrodes according to the invention.

As another aspect of the present invention, a method for driving a thin-film electroluminescent display is disclosed. In the method, the thin-film electroluminescent display comprises a high voltage node supplying a driving voltage (VH), a low voltage node supplying a low voltage (VL), a thin-film display element extending substantially along a base plane defining a lateral extension of the thin-film display element. The thin-film display element comprises a common layer comprising common electrodes, a segment layer comprising segment electrodes, the segment electrodes arranged at least partially to laterally overlap with the common electrodes. The thin-film display element comprises also a luminescent layer arranged between the common layer and the segment layer. The thin-film electroluminescent display comprises a common driver comprising common connections, each of the common connections connected to one of the common electrodes. The method comprises steps of
feeding segment driving voltage signals by a segment driver to the segment electrodes during a driving period,
feeding a common driving voltage signal sequentially to a driven common electrode during the driving period through one of the common connections, the driven common electrode being one of the common electrodes,
   setting one or more undriven common electrodes and the common connections connected to the one or more undriven common electrodes to a high impedance state during the driving period, the one or more undriven common electrodes being the common electrodes other than the driven common electrode,
producing visible light with the luminescent layer when a voltage difference between the common electrodes and the overlapping segment electrodes exceeds a threshold voltage. The method comprises further a step of
limiting the voltage of the one or more undriven common electrodes caused by the segment driving voltage signals during the driving period to a voltage which may vary within a limited voltage range with voltage limiters connected to each of the common connections. Advantage of the voltage limiting is that erroneous light production due to current paths created by the one or more undriven common electrodes in the high impedance state is hindered.

Thus, erroneous light production due to current paths created by the one or more undriven common electrodes in the high impedance state is hindered.

The common driver may perform the step of limiting the voltage of the one or more undriven common electrodes.

In an embodiment of the method, the limited voltage range has an upper bound which is the threshold voltage, and a lower bound which is the driving voltage less the threshold voltage. These upper and lower bounds are advantageous to guarantee that no erroneous light production occurs when executing the method.

In an embodiment of the method, the method aspect and its embodiments are executed in the thin-film electroluminescent display according to the thin-film electroluminescent display aspect of the invention and its embodiments.

The invention is based on the idea of limiting the voltage of the floating common electrodes (that is, a common electrode set to “a high impedance state”, also denoted as “a high Z state”) to a limited voltage range that, relative to the segment electrodes, does not allow the voltage from a segment electrode to a floating common electrode to exceed the threshold voltage that would lead to an erroneous light output from the area of the segment electrode overlapping the floating common electrode. The voltage of the floating common electrode is caused by the series connection of at least one segment-common electrode capacitance, and one common-segment electrode capacitance, and the voltages driven to the respective segment electrodes.

An advantage of the invention is that more complex TFEL common electrode layouts can be designed and manufactured, relaxing the difficulty related to the segment electrode layouts and their traces considerably.

For the purposes of this text, unless otherwise specified, a “connection” means an “electrical connection”. Similarly, the word “connect” or “connected” means, unless otherwise specified, that the connected items are electrically connected with an intended, non-parasitic electrical connection. The connection may comprise electrical components or elements, or be a “direct”, galvanic connection.

For the purposes of this text, the concepts “voltage node” and “circuit node” are used interchangeably.

For the purposes of this text, both “TFEL” and “TFEL display” mean a “thin-film electroluminescent display”.

For the purposes of this text, something occurring “during” a period of time means that something occurs within the period of time, but not necessarily from the start of the period of time, or till the end of the period of time, or from the start till the end of the period of time.

For the purposes of this text, a “high impedance state”, a “floating state” or a “high Z” state mean the same thing, an electrical structure, for example an electrode like a common electrode which is not driven actively to a certain voltage with for example a common driving voltage signal.

For the purposes of this text, a layer A “on” another layer B does not require that the layers A and B touch each other. In other words, layer A on layer B does not require that layers A and B are “directly” “on” each other.

### BRIEF DESCRIPTION OF THE DRAWINGS

The invention is described in detail by means of specific embodiments with reference to the enclosed drawings, in which

FIGS. 1a and 1b show schematically a prior art TFEL display,

FIGS. 2a-3c show schematically a technical problem related to a TFEL with more than one common electrodes, and segment electrodes with various sizes,

FIGS. 4a and 4b show a TFEL display and a driving diagram related to the driving of the TFEL according to the invention and its embodiments,

FIG. 5a illustrates various voltage levels of the invention and its embodiments,

FIG. 5b illustrates an embodiment of the invention,

FIGS. 6a-6c illustrate details of some embodiments of the present invention,

FIGS. 7a-7c define features of various field effect transistors and their control,

FIG. 8 illustrates a TFEL display element with various sizes of segment electrodes, and

FIG. 9 illustrates a method aspect of the current invention and its embodiments.

### DETAILED DESCRIPTION OF THE INVENTION

Throughout the following description and in the associated Figures, like numbers (for example 70) and like labels (for example 91b) denote like elements.

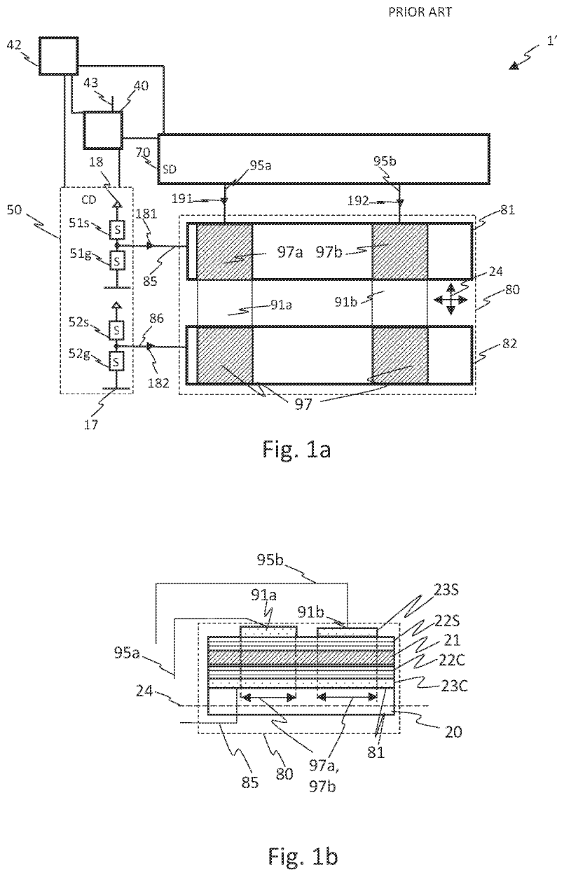

FIGS. 1a and 1b show schematically a prior art thin-film electroluminescent display 1′. FIG. 1a shows a projection from above the display 1, and FIG. 1b a cutting plane projection through the common electrode 81. The TFEL display comprises a thin-film display element 80 extending substantially along a base plane 24 defining a lateral extension of the thin-film display element 80. The thin-film display element 80 comprises a common layer 23C that comprises common electrodes 81, 82 separated from one another. In other words, the common layer 23C is patterned to comprise the common electrodes 81, 82 and electrically conductive traces or interconnections that connect the common electrodes to a contact area of the thin-film display element 80 (contact area not shown).

Common electrodes may be fabricated for example with sputtering some conductive, yet transparent material like indium doped tin oxide (“ITO”) or other such transparent, yet electrically conductive oxide or other chemical compound on a substrate 20. Substrate 20 may comprise transparent material like soda lime glass, aluminium silicate glass, or some ceramic material, or an organic material withstanding high process temperatures during the thin-film deposition processes. Common layer 23C may be patterned for example by lithography and etching.

There may also be additional layers between the common layer 23C and the substrate 20, for example a thin aluminium oxide (Al₂O₃) layer for blocking leaching of ions like sodium ions from the substrate 20, deposited with an atomic layer deposition (“ALD”) method.

As in FIG. 1a, the common electrodes 81, 82 can also be considered as “row” electrodes as they (in the present orientation) act as finger-like rows 81 and 82.

The thin-film display element 80 comprises also a segment layer 23S comprising segment electrodes 91a, 91b, the segment electrodes 91a, 91b arranged at least partially to laterally overlap 97, 97a, 97b with the common electrodes 81, 82.

The segment layer 23S may be fabricated similarly to the common layer 23C. Both layers 23S and 23C may have a thickness of for example 200-800 nm. The thicker the layers 23C and 23S are, the more conducting the electrodes and interconnecting traces are, but the less transparent and optically clear the layer also is.

The TFEL display 1 may be readily also arranged such that the segment layer 23S is deposited or otherwise arranged closer to the substrate 20 than the common layer 23C.

The segment layer 23S is also patterned to comprise the segment electrodes and the interconnecting traces. The segment layer 23S may also be patterned for example by lithography and etching.

If both the segment layer 23S and the common layer 23C are transparent (for example arranged of ITO or other such transparent, yet electrically conductive material), the display is transparent, as the other layers (22S, 22C and 21, and the substrate 20) are also essentially transparent.

As in FIG. 1a, the segment electrodes can also be considered as “column” electrodes as they (in the present orientation) act as finger-like columns 91a and 91b.

Thus, the display in FIG. 1a may be considered as a “matrix” type of TFEL display. If the segment electrodes 91a and 91b (and possibly more segment electrodes) would have shapes of pictograms or other symbols, and if there would be only one common electrode 81, the TFEL would be a normal “segment” type of TFEL display.

The thin-film display element 80 comprises further a luminescent layer 21 arranged between the common layer 23C and the segment layer 23S. The luminescent layer 21 produces visible light 99a when a voltage difference exceeding a threshold voltage VT is arranged between the common electrodes 81, 82 and the overlapping segment electrodes 91a, 91b.

A typical threshold voltage VT is 140V for a TFEL display with a driving voltage amplitude of 195V.

The luminescent layer 21 may be readily fabricated with the atomic layer deposition (ALD) method. The luminescent layer 21 may comprise for example manganese doped zinc sulphide (ZnS:Mn) or terbium doped zinc sulphide (ZnS:Tb) for primarily yellow or green light output, respectively. Thickness of the luminescent layer may be for example 100 nm-300 nm.

The thin-film electroluminescent display 1′ comprises also a segment driver 70 arranged to feed segment driving voltage signals 191, 192 to the segment electrodes 91a, 91b during a driving period.

For the purposes of this text, a “driving period” is a period of time during which one common electrode is fed with a common driving voltage signal, and the other common electrodes are left to a floating or high impedance (high Z) state during the driving period. The segment driver 70 is arranged to feed the segment driving voltage signals 191, 192 to the segment electrodes 91a, 91b during each of the driving periods ta, tb, tc, td.

The segment driving voltage signals 191, 192 may be fed to the segment electrodes 91a, 91b through segment connections 95a, 95b.

The segment connections 95a and 95b may comprise interconnections from the segment driver 70 and interconnections (like connection area or pad area) to the thin-film display element 80, conductors between the segment driver 70 and the thin-film display element 80, and traces on the segment layer 23S to the segment electrodes 91a, 91b.

For the purpose of driving the common electrodes 81, 82, the TFEL display comprises also a common driver 50 comprising common connections 85, 86, each of the common connections 85, 86 connected to one of the common electrodes 81, 82. In other words, each of the common connections 85, 86 is connected or electrically paired with the corresponding common electrode 81, 82 such that each one of the common connections 85, 86 and each one of the common electrodes 81, 82 form a pair. Thus, one common connection 85, 86 is connected to one common electrode 81, 82. Connection to the common electrodes 81, 82 may also comprise conductors, interconnecting elements and traces on the common layer 23C.

The common driver 50 is arranged to feed a common driving voltage signal 181, 182 sequentially (one at a time, and in some sequence) to a driven common electrode of the common electrodes 81, 82 during a driving period ta, tb, tc, td through one of the common connections 85, 86. The common driver 50 is arranged also to set the one or more undriven common electrodes 81, 82 and the corresponding common connections 85, 86 to a high impedance state during the driving period ta, tb, tc, td.

To arrange the common driving voltage signals 181, 182, the common driver 50 may comprise switches 51s, 51g, 52s, 52g that connect the common connection 85, 86 to a high voltage node 18, or to a low voltage node 17 to drive the common electrode 81, 82 to a driven state.

To leave the common connection 85, 86 and the corresponding one or more undriven common electrodes to a high impedance state, both switches 51s and 51g, or 52s and 52g may be arranged into a non-conducting or open state.

Thus, the addressing of which row/common electrode is to produce light is configured to occur from one driving period to another, and from one common electrode to another. To operate, each of the common electrodes is sequentially fed with common driving voltage signals 181, 182 during the driving periods ta, tb . . . , until the last common electrode is driven, after which the sequence of feeding the common electrodes starts again. This is a so called “passive matrix” addressing scheme in domain of display technologies. The aggregate duration of driving periods ta, tb . . . is the so-called refresh time ts of the TFEL display, and the inverse 1/ts is the so-called refresh rate of the TFEL display. Thus, for the purposes of this text, the concept “sequentially” means that each of the common electrodes is fed with a common driving voltage signal one at a time.

The thin-film display element 80 may further comprise a first dielectric layer 22C on a first side of the luminescent layer 21, and a second dielectric layer 22S on a second side of the luminescent layer 21, the first dielectric layer 22C, the second dielectric layer 22S and the luminescent layer 21 arranged between the common layer 23C and the segment layer 23S. Purpose of the dielectric layers 22C and 22S is to provide electrical insulation and limit the current flowing between segment electrodes and common electrodes.

The first and second dielectric layers 22C and 22S may comprise for example a nanolaminate of aluminium and titanium oxides, and their thickness may be for example 100 nm-300 nm each.

Clearly, in terms of electrical circuit theory, an overlapping pair of a segment and a common electrode is essentially a “parallel plate capacitor”, with said overlapping areas of the electrodes being the capacitor plates, and the luminescent layer and potential dielectric layers as the insulating material between the plates. The capacitance C of such a parallel plate capacitor is determined by the separation s of the plates, area of the plates (that is, the area of the segment/common electrode overlap) A and effective permittivity εEFF of the insulating material between the segment layer 23S and common layer 23C according to formula C=εEFF A/s. Thus, as the separation and effective permittivity remain essentially constant over the entire thin-film display element 80, the areas A of the overlaps of the segment/common electrodes defines the relative difference of the segment/common capacitances.

The TFEL display 1′ may also comprise a power unit 42 arranged to feed energy for the operations of the display. The power unit 42 may comprise transformers to provide different voltage levels needed for the operation for the display 1′.

To supply different voltages, the TFEL display 1′ may comprise a high voltage node 18 supplying a driving voltage VH. The driving voltage may be for example 195V or a voltage between 180V and 205V. One high voltage node 18 may be arranged in conjunction with the common driver 50.

The TFEL display 1′ may also comprise a low voltage node 17 supplying a low voltage VL. The low voltage VL may be a zero voltage. One or more low voltage nodes 17 may be also arranged in conjunction with the common driver 50.

The TFEL display 1′ may comprise also control unit 40 arranged to command the common driver 50 and the segment driver 70 to produce correct common driving voltage signals 181, 182, and segment driving voltage signals 191,192, respectively. The control unit 40 may operate based on information received from an interface 43. Interface 43 may be, for example, an SPI interface, an I2C interface, or a CANBus interface.

Functionality of the common driver 50 and segment driver 70 may also combined into or provided with a commercially available integrated circuit, for example the HV509 chip available from Supertex Inc. or Microchip Inc. The HV509 chip is a 16-channel serial to parallel converter with a high voltage backplane driver and push-pull outputs capable of 200V, 16 channel output. Several HV509 chips can be cascaded for the output of over 16 channels. Herein, one channel means one segment electrode/common electrode pair.

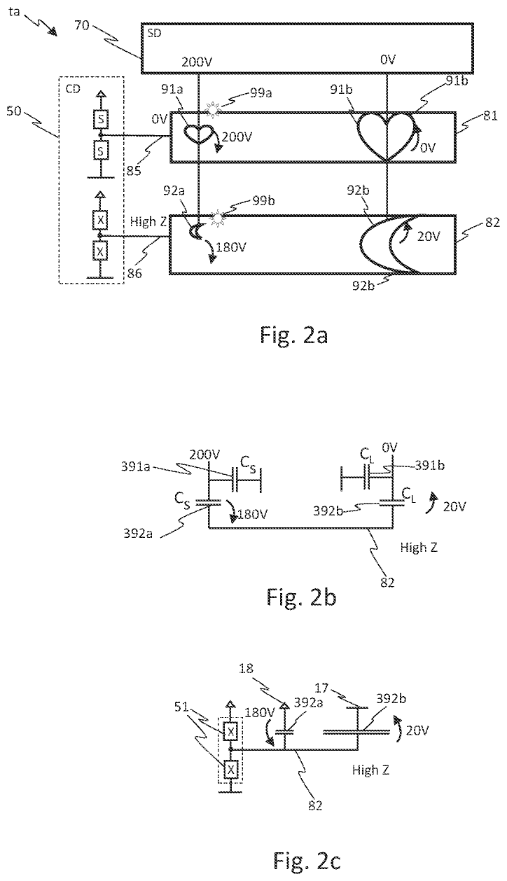

Turning next to FIGS. 2a-2c, the problem in the prior art is illustrated in more detail. In FIG. 2a, the common electrode 81 is fed with a common driving voltage signal during a drive period ta to enable light production from the segments 91a and 91b overlapping the common electrode 81. In this case, the common driving voltage signal comprises a zero voltage, and thus the segment driving voltage signal determines if a segment produces light or not. Segment 91a is fed with a segment driving voltage signal comprising a 200V voltage. This voltage is typical for TFELs. Thus, there is a voltage difference of 200V between the corresponding common electrode 81 and segment electrode 91a, and segment 91a produces light, marked with label 99a. Related to segment 91b, it is fed with 0V, and thus no voltage difference between electrodes 81 and 91b is provided, and no light output occurs from segment electrode 91b.

Common electrode 82 is in a high impedance state. Two segment electrodes, 92a and 92b, overlap the common electrode 82. Segment electrode 92a is also fed with the 200V voltage, and segment electrode 92b with the 0V. Thus, as shown in FIG. 2b, a current path created by the common electrode 82, which is not actively set to any voltage by the common driver 50 during the time period ta, is created. Capacitance (or equivalent capacitor) of the segment 91a (with common electrode 81) is CS, shown with label 391a, and capacitance of the segment 92a (with common electrode 82) is also CS, shown with label 392a. Capacitance of the segment 91b (with common electrode 81) is CL, shown with label 391b, and capacitance of the segment 92b (with common electrode 82) is also CL, shown with label 392b.

As shown in FIG. 2a, segment electrodes 91a and 92a are “small” relative to segment electrodes 91b and 92b, for example areas of 91a and 92a may have an area (more specifically, area of overlap between corresponding segment/common electrodes) which is 11,1% ( 1/9) of the area of electrodes 91b and 92b. Capacitances 392a and 392b are in a series connection through common electrode 82, and this series connection has 200V over it. As the segment/common electrode pairs are essentially parallel plate capacitors, owing to the elementary division of voltage over capacitors in series, capacitor 392a has 200V*(9/(1+9))=180V over it, and capacitor 392b 200V*( 1/10)=20V over it. Naturally, 180V+20V=200V.

Thus, a prior art problem is that the here-presented 180V exceeds the threshold voltage of light production (VT) in the display of FIG. 2b, which may be for example 135V-145V. Thus, an erroneous light production 99b occurs. The prior art problem remains as long as segment electrodes overlapping one same common electrode are substantially of different area, and the TFEL display comprises at least two separate common electrodes that are addressed separately in time. It is to be noted that in a normal matrix TFEL display, the area of the segments is identical as the segments are identical pixels in a display matrix. Thus, this problem is not encountered in a normal matrix TFEL display and thus has remained unsolved even when the basic TFEL technology dates back to 1980s.

FIG. 2c illustrates that a floating state of the common electrode 82 is arranged by decoupling the common electrode 82 from the high voltage node 18 and low voltage node 17 of the common driver 50. However, these voltages set the voltage of the floating common electrode 82 through capacitances 392a and 392b as they are also present in the segment driver 70.

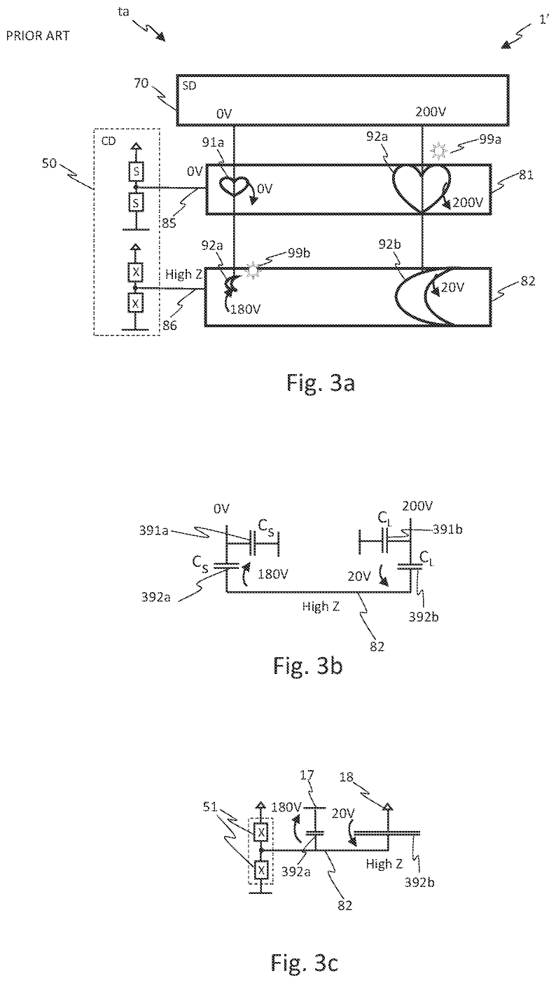

FIGS. 3a-3b correspond to FIGS. 2a-2c, and they illustrate that by arranging the 200V segment voltage driving signal to the segment electrode 92a, and the 0V signal to segment electrode 91a, erroneous light output 99b occurs again from segment electrode 92a, but the polarities of voltages over capacitors related to segment electrodes 92a and 92b are reversed. Reversing polarities in an alternating way in the TFEL displays is, as such, a normal way of operating a TFEL display, but the prior art problem of erroneous light production remains.

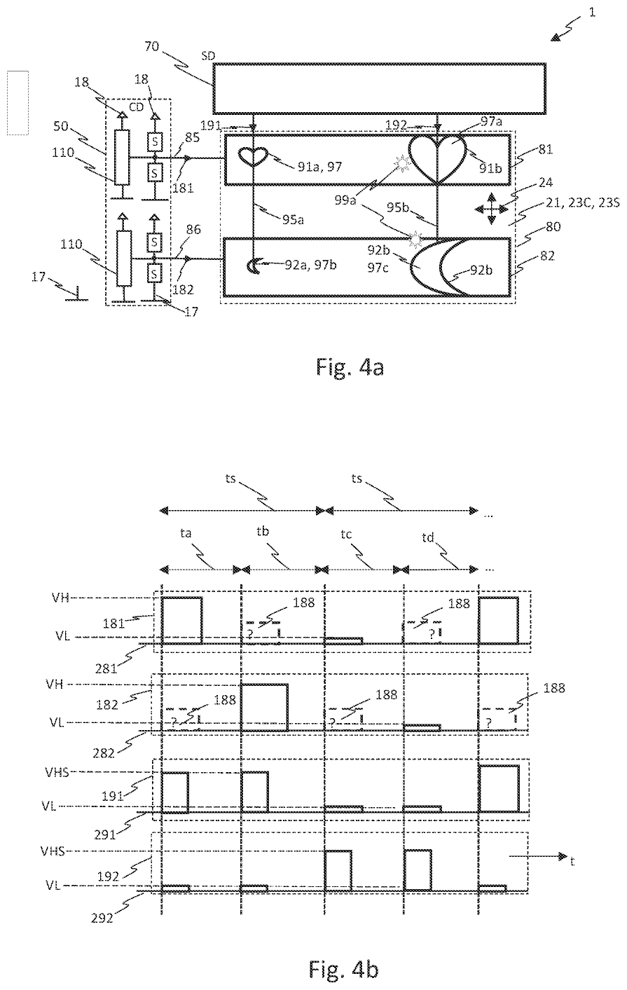

Turning to FIGS. 4a and 4b, according to an aspect of the present invention, a thin-film electroluminescent display 1 is disclosed. The thin-film electroluminescent display comprises a high voltage node 18 supplying a driving voltage VH, a low voltage node 17 supplying a low voltage VL, and a thin-film display element 80 extending substantially along a base plane 24 defining a lateral extension of the thin-film display element 80.

The thin-film display element 80 comprises a common layer 23C comprising common electrodes 81, 82, and a segment layer 23S comprising segment electrodes 91a, 91b, 92a, 92b. The segment electrodes 91a, 91b, 92a, 92b are arranged at least partially to laterally overlap 97, 97a, 97b, 97c with the common electrodes 81, 82. The areas and shapes of overlaps 97, 97a, 97b, 97c determines the areas of light output of the emissive TFEL display.

The thin-film display element 80 comprises also a luminescent layer 21 arranged between the common layer 23C and the segment layer 23S. The luminescent layer 21 is arranged to produce visible light 99a when a voltage difference exceeding a threshold voltage VT is arranged between the common electrodes 81, 82 and the overlapping (overlaps marked with labels 97, 97a, 97b, 97c) segment electrodes 91a, 91b, 92a, 92b,

The thin-film electroluminescent display 1 comprises further a segment driver 70 arranged to feed segment driving voltage signals 191, 192 to the segment electrodes 91a, 91b, 92a, 92b during a driving period ta, tb, tc, td.

The thin-film electroluminescent display 1 comprises also a common driver 50 comprising common connections 85, 86, each of the common connections 85, 86 connected to one of the common electrodes 81, 82.

The common driver 50 is arranged to feed a common driving voltage signal 181, 182 sequentially to a driven common electrode of the common electrodes 81, 82 during the driving period ta, tb, tc, td through one of the common connections 85, 86, and also set the one or more undriven common electrodes 81, 82 and the corresponding common connections 85, 86 to a high impedance state during the driving period ta, tb, tc, td.

In other words, the common driver 50 is arranged to the feed a common driving voltage signal 181, 182 sequentially to a driven common electrode during the driving period ta, tb, tc, td through one of the common connections 85, 86, the driven common electrode being one of the common electrodes 81, 82. The common driver 50 is also arranged to set one or more undriven common electrodes 81, 82 and the common connections connected to the one or more undriven common electrodes 81, 82 to a high impedance state during the driving period ta, tb, tc, td. The one or more undriven common electrodes 81, 82 are the common electrodes 81, 82 other than the driven common electrode 81, 82.

As an aspect of the invention, each of the common connections 85, 86 comprises a voltage limiter 110. The voltage limiter 110 is arranged to limit voltage of the one or more undriven common electrodes 81, 82 caused by the segment driving voltage signals 191, 192 during the driving period ta, tb, tc, td to a voltage which may vary within a limited voltage range 186.

Thus, with the voltage limiters 110 connected as above, the segment driving voltage signals 191, 192 cannot cause voltages that cause erroneous light output at the segment electrodes overlapping the undriven, floating common electrodes.

Like the prior art display 1′, the TFEL display 1 may also comprise a power unit 42 arranged to feed energy for the operations of the display. The power unit 42 may comprise transformers to provide different voltage levels needed for the operation for the display 1.

The high voltage node 18 supplying a driving voltage VH may have a voltage of for example 195V or a voltage between 180V and 205V. One high voltage node 18 may be arranged in conjunction with the common driver 50.

The low voltage node 17 supplying a low voltage VL may have a zero voltage, a ground voltage of the common driver 50, or a voltage of, for example 1-5V. One low voltage node 17 may be also arranged in conjunction with the common driver 50.

Like the prior art display 1′, the TFEL display 1 may also comprise also control unit 40 arranged to command the common driver 50 and the segment driver 70 to produce correct common driving voltage signals 181, 192, and segment driving voltage signals 191,192, respectively. The control unit 40 may operate based on information received from an interface 43, like an SPI, an I2C or a CanBUS interface.

For units 40, 42 and 43, FIG. 1a is referred to.

The thin-film display element 80 may also comprise a first dielectric layer 22C on a first side of the luminescent layer 21, and a second dielectric layer 22S on a second side of the luminescent layer 21. The first dielectric layer 22C, the second dielectric layer 22S and the luminescent layer 21 may be arranged between the common layer 23C comprising the common electrodes 81, 82, and the segment layer 23S comprising the segment electrodes 91a, 91b, 92a, 92b.

As shown further in FIG. 4b, the common driving voltage signal 181,182 may be arranged to a driving voltage VH or to a low voltage VL during the driving period ta, tb, tc, td. In other words, the driving voltage alternates between a segment and a common electrode in polarity, as the segment driving voltage signal may also vary in the same range.

For example, during driving period ta, common driving voltage signal 181 fed to the common electrode 81 is at the high voltage VH during the driving period ta on time axis 281. At the same driving period ta, common driving voltage signal 182 is not fed to the common electrode 82, and thus the voltage of the common electrode is floating but still limited, indicated by symbol 188, as shown on time axis 282.

As a further example, during driving period tb, the common electrode 81 is set into the high impedance state and the common electrode 82 is fed with the common driving voltage signal 182, which is at high voltage VH during driving period tb. At the same time, the common electrode 81 is at a floating state.

Driving period tc may have the common driving voltage signal 181 set to a low voltage, and the common electrode 82 again in a floating but limited state 188.

Driving period td may have the common driving voltage signal 182 set to a low voltage, and the common electrode 81 again in a floating but limited state 188.

As also shown in FIG. 4b, each of the segment driving voltage signals 191, 192 may be arranged to a segment driving voltage VHS or to a low voltage VL during each of the driving period ta, tb, tc, td as shown on time axes 291 and 292.

The segment driving voltage VHS may be the same as the driving voltage VH.

In the example above, segment electrodes 91a and 92a do not produce light as the voltage difference from the segment electrode to the common electrode is zero or close to zero. Segment electrodes 91b and 92b produce light 99a as the voltage difference from the segment electrode to the common electrode is VH-VL, or VL-VH, exceeding the threshold voltage. However, no erroneous light production occurs as the voltage of the common electrodes 81, 82 that are set to a floating state during driving periods is limited according to the invention.

As also shown in FIG. 4b, the combined time to feed all the common electrodes 81, 82 with common driving signals at corresponding driving periods ta, tb and tc, td is the refresh time ts=ta+tb, which may be also ts=tc+td, and the inverse of the refresh time ts is the refresh rate 1/ts.

In an embodiment, the thin-film display element 80 is transparent.

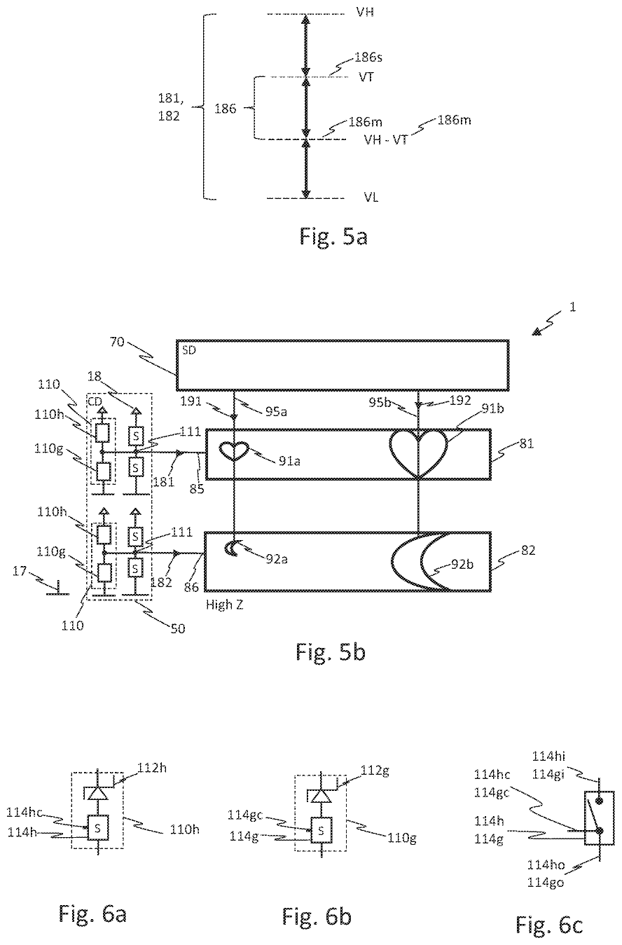

In an embodiment of the thin-film electroluminescent display 1, the limited voltage range 186 has an upper bound 186s which is the threshold voltage VT, and a lower bound 186m which is the driving voltage VH less the threshold voltage VT. This is illustrated in FIG. 5a. This voltage range ensures that no erroneous light output occurs.

An optimal driving voltage and threshold voltage depend mostly on the thickness of the luminescent layer 21, and the possible first and second dielectric layers, and the doping, for example manganese doping, of the luminescent layer, for example zinc sulphide.

The driving voltage VH may be 185V-205V, for example 195V, and the threshold voltage VT may be 135V-145V. Assuming VH=200V and VT=140V, driving voltage VH less the threshold voltage VT is: VH−VT=200V−140V=60V.

The driving voltage may be 75V-85V, for example 80V. The threshold voltage VT may be 50V-60V, for example 55V.

The low voltage VL of FIG. 5a may be zero volts.

The low voltage VL of FIG. 5a may be the ground voltage level of the common driver 50.

Turning to FIG. 5b, in an embodiment of the thin-film electroluminescent display 1, the voltage limiter 110 comprises a high voltage side limiter 110h connected between the high voltage node 18 and the common connection 85, 86, and a low voltage side limiter 110g connected between the low voltage node 17 and the common connection 85, 86. This is an advantageous arrangement as it makes possible to control the upper and lower bounds of the limited voltage range efficiently.

In an embodiment, the high voltage side limiter 110h is arranged to set the lower bound 186m of the limited voltage range 186, and the low voltage side limiter 110g is arranged to set the upper bound 186s of the limited voltage range 186.

In an embodiment, the high voltage side limiter 110h is arranged to set the upper bound 186s of the limited voltage range 186, and the low voltage side limiter 110g is arranged to set the lower bound 186m of the limited voltage range 186.

Turning to FIG. 6a, in an embodiment of the thin-film electroluminescent display 1, the high voltage side limiter 110h comprises a series connection of a high voltage side zener diode 112h and a high voltage side switching circuit 114h, the high voltage size zener diode 112h having a zener voltage which is smaller or equal to the threshold voltage VT, and larger or equal to the driving voltage VH less the threshold voltage VT. A switched zener diode is an efficient implementation of the voltage limiter.

A zener diode is a special type of diode designed to reliably allow current to flow backwards (in the reverse direction) when a certain set or predetermined reverse voltage, known as the zener voltage, is reached.

Still referring to FIG. 6a, in an embodiment of the thin-film electroluminescent display 1, the common driver 50 is arranged to control the high voltage side switching circuit 114h connected to the one or more undriven common electrodes 81, 82 to a conducting state during the driving period ta, tb, tc, td.

In an embodiment of the thin-film electroluminescent display 1, the common driver 50 is arranged to control the high voltage side switching circuit 114h connected to the driven common electrode 81, 82 to a non-conducting state during the driving period ta, tb, tc, td.

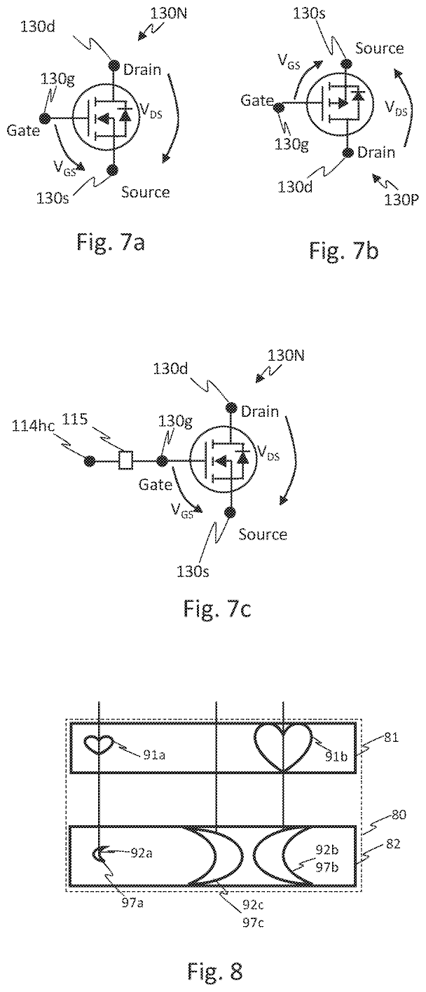

Turning to FIGS. 6c and 7b, in an embodiment of the thin-film electroluminescent display 1, the high voltage side switching circuit 114h comprises a P-channel field effect transistor 130P having a gate node 130g connected to a control node 114hc of the high voltage side switching circuit 114h.

In an embodiment, the high voltage side switching circuit 114h comprises a P-channel field effect transistor 130P having a source node 130s connected to an input node 114hi of the high voltage side switching circuit 114h, and drain node 130d connected to an output node 114ho of the high voltage side switching circuit 114h.

Turning to FIGS. 6c and 7c, in an embodiment of the thin-film electroluminescent display 1, the high voltage side switching circuit 114h comprises an N-channel field effect transistor 130N having a gate node 130g being connected to a gate driver unit 115, the gate driver unit 115 being connected to a control node 114hc of the high voltage side switching circuit 114h.

In an embodiment, the high voltage side switching circuit 114h comprises an N-channel field effect transistor 130N having a drain node 130d connected to an input node 114gi of the switching circuit, a source node 130s being connected to an output node 114go of the switching circuit, and a gate node 130g being connected to a gate driver unit 115, the gate driver unit 115 being connected to a control node 114hc of the high voltage side switching circuit 114h. The gate driver unit 115 may be arranged to supply a voltage level to the gate 130g of the N-channel field effect transistor 130N such that the voltage between the gate 130g and the source 130s of the N-channel field effect transistor 130N may be set to a high-enough voltage to enable switching operation of the N-channel field effect transistor 130N, and to turn the N-channel field effect transistor 130N to a conducting (closed) state when so controlled. Gate driver units for N-channel field effect transistors are readily commercially available.

Turning to FIG. 6b, in an embodiment of the thin-film electroluminescent display 1, the low voltage side limiter 110g comprises a series connection of a low voltage side zener diode 112g and a low voltage side switching circuit 114g, the low voltage size zener diode 112g having a zener voltage which is smaller or equal to the threshold voltage VT, and larger or equal to the driving voltage VH less the threshold voltage VT. A switched zener diode is an efficient implementation of the voltage limiter.

In an embodiment of the thin-film electroluminescent display 1, the common driver 50 is arranged to control the low voltage side switching circuit 114g connected to the one or more undriven common electrodes 81, 82 to a conducting state during the driving period ta, tb, tc, td.

In an embodiment of the thin-film electroluminescent display 1, the common driver 50 is arranged to control the low voltage side switching circuit 114g connected to the driven common electrode 81, 82 to a non-conducting state during the driving period ta, tb, tc, td.

Turning to FIGS. 6c and 7a, in an embodiment of the thin-film electroluminescent display 1, the low voltage side switching circuit 114g comprises an N-channel field effect transistor 130N having a gate node connected to a control node 114gc of the low voltage side switching circuit 114g.

In an embodiment, the low voltage side switching circuit 114g comprises an N-channel field effect transistor 130N having a drain node 130d connected to an input node 114gi of the switching circuit and source node 130s connected to an output node 114go of the switching circuit.

Turning back to FIG. 4a, in an embodiment of the thin-film electroluminescent display 1, at least one of the segment electrodes 92a has a different area than the other segment electrodes 91a, 91b, 92a. This kind of configuration highlights the advantages of the invention and its embodiments.

Turning next to FIG. 8, in an embodiment of the thin-film electroluminescent display 1, one of the segment electrodes 92a overlapping one common electrode 82 has an area of overlap 97a which is different than the areas of overlaps 97b, 97c of the one or more other segment electrodes 92b, 92c overlapping the same one common electrode 82. This kind of configuration highlights further the advantages of the invention and its embodiments.

As in FIG. 8, in an embodiment of the thin-film electroluminescent display 1, one of the segment electrodes 92a overlapping one common electrode 82 has an area of overlap 97a which is less than a fraction F of the combined area of overlaps 97b, 97c of the one or more other segment electrodes 92b, 92c overlapping the same one common electrode 82, such that F is equal to a value of VH/VT−1, where VH is the driving voltage, and VT is the threshold voltage. Advantage of this embodiment stems from considering a small capacitor CS related to an area of overlap 97a of segment electrode 92a, and a parallel connection of other capacitors CL comprising areas of all the overlaps of 97b and 97c of segment electrodes 92b and 92c. Further, assuming that CS is connected to VH and CL is connected to a VL which may be a zero voltage. In this case, CS and CL are arranged in series.

Now VH is applied over CS and CL in series, and thus voltage over the small capacitor CS is (CL/(CS+CL))*VH, and if we set this to the light production threshold voltage VT, a capacitor (and the equivalent area of overlap) that may experience erroneous light production 99b without the voltage limitation according to the present invention is smaller than or equal to CS=((VH/VT)−1) CL.

It is to be noted that, as discussed already above, the capacitance is directly proportional to the area of overlaps of the segment and common electrodes.

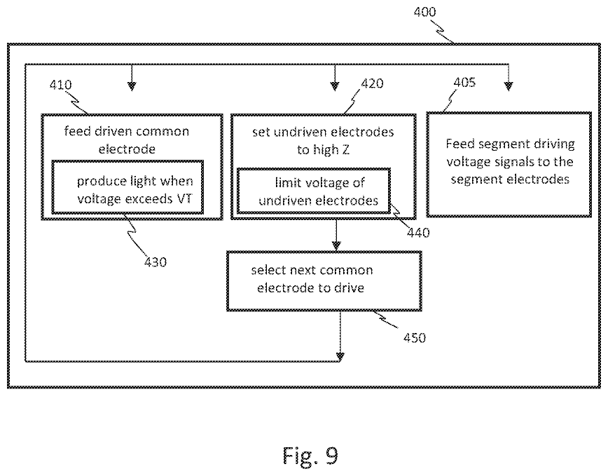

Turning next to FIG. 9 and referring back to FIG. 4a, as an aspect of the present invention, a method 400 for driving a thin-film electroluminescent display 1 is disclosed. The thin-film electroluminescent display 1 comprises a high voltage node 18 supplying a driving voltage VH, a low voltage node 17 supplying a low voltage VL, a thin-film display element 80 extending substantially along a base plane 24 defining a lateral extension of the thin-film display element 80. The thin-film display element 80 comprises also a common layer 23C comprising common electrodes 81, 82, a segment layer 23S comprising segment electrodes 91a, 91b, 92a, 92b. The segment electrodes 91a, 91b, 92a, 92b are arranged at least partially to laterally overlap 97, 97a, 97b, 97c with the common electrodes 81, 82. The thin-film display element 80 comprises a luminescent layer 21 arranged between the common layer 23C and the segment layer 23S. The thin-film electroluminescent display 1 comprises also a common driver 50 comprising common connections 85, 86, each of the common connections 85, 86 connected to one of the common electrodes 81, 82. The method 400 comprises steps of:
feeding (as step 405) segment driving voltage signals 191, 192 by a segment driver 70 to the segment electrodes 91a, 91b, 92a, 92b during a driving period ta, tb, tc, td,
   feeding (as step 410) a common driving voltage signal 181, 182 sequentially to a driven common electrode during the driving period ta, tb, tc, td through one of the common connections 85, 86, the driven common electrode being one of the common electrodes (81, 82),
   setting (as step 420) one or more undriven common electrodes 81, 82 and the common connections 85, 86 connected to the one or more undriven common electrodes to a high impedance state during the driving period ta, tb, tc, td, the one or more undriven common electrodes 81, 82 being the common electrodes 81, 82 other than the driven common electrode 81, 82,
producing (as step 430) visible light 99a with the luminescent layer 21 when a voltage difference between the common electrodes 81, 82 and the overlapping segment electrodes 91a, 91b, 92a, 92b exceeds a threshold voltage VT. The method 400 also comprises a step of limiting (as step 440) the voltage of the one or more undriven common electrodes 81, 82 caused by the segment driving voltage signals 191, 192 during the driving period ta, tb, tc, td to a voltage which may vary within a limited voltage range 186 with voltage limiters 110 connected to each of the common connections 85, 86.

Thus, each of the common connections 85, 86 comprises a voltage limiter 110.

Aspects and units of the TFEL display 1 are already defined above in more detail in the display aspect and its embodiments of the present invention.

It is to be noted that the steps of feeding (step 405) segment driving voltage signals, feeding (step 410) a common driving voltage signal, setting (step 420) the one or more undriven common electrodes to high Z state, producing (step 430) visible light 99a with the luminescent layer, and limiting (step 440) the voltage of the one or more undriven common electrodes may occur concurrently or at least partially concurrently, in other words, at the same time, or at least partially at the same time.

Referring still to FIG. 9, after one driven common electrode is fed with the common electrode driving signal, a next common electrode to be driven may be selected (as step 450).

After steps 405-450 are performed, they may be performed again to operate the TFEL display 1 to continuously present information on the TFEL display 1, possibly changing the segment driving voltage signal information to segment electrodes to alternate the information output of the TFEL display 1.

Above, feeding a common driving voltage signal 181, 182 sequentially means that the common driving voltage signal, for example 181, is fed to one common electrode, for example 81, during one driving period ta. During the next driving period tb, another common driving voltage signal, for example 182, is fed to another common electrode, for example common electrode 82.

In an embodiment of the method 400 for driving a thin-film electroluminescent display 1, the limited voltage range 186 has an upper bound 186s which is the threshold voltage VT, and a lower bound 186m which is the driving voltage VH less the threshold voltage VT. Said voltages VH and VT are defined above in more detail also in the display aspect and its embodiments of the present invention.

In an embodiment of the method 400 for driving a thin-film electroluminescent display 1, the method is executed in the thin-film electroluminescent display 1 according to the display aspect and its embodiments of the current invention.

The invention has been described above with reference to the examples shown in the figures. However, the invention is in no way restricted to the above examples but may vary within the scope of the claims.

1. A thin-film electroluminescent display comprising:
a high voltage node supplying a driving voltage;
a low voltage node supplying a low voltage;
a thin-film display element extending substantially along abase plane defining a lateral extension of the thin-film display element, the thin-film display element comprising:
a common layer comprising common electrodes;
a segment layer comprising segment electrodes, the segment electrodes arranged at least partially to laterally overlap with the common electrodes; and
a luminescent layer arranged between the common layer and the segment layer, the luminescent layer arranged to produce visible light when a voltage difference exceeding a threshold voltage is arranged between the common electrodes and the segment electrodes;
a segment driver arranged to feed segment driving voltage signals to the segment electrodes during a driving period,
a common driver comprising common connections, each of the common connections connected to one of the common electrodes, the common driver arranged to:
feed a common driving voltage signal sequentially to a driven common electrode during the driving period through one of the common connections, the driven common electrode being one of the common electrodes; and
set one or more undriven common electrodes and the common connections connected to the one or more undriven common electrodes to a high impedance state during the driving period, the one or more undriven common electrodes being the common electrodes other than the driven common electrode; wherein each of the common connections comprises a voltage limiter arranged to limit voltage of the one or more undriven common electrodes caused by the segment driving voltage signals during the driving period to a voltage which may vary within a limited voltage range.

2. The thin-film electroluminescent display according to claim 1, wherein the limited voltage range has:
an upper bound which is the threshold voltage; and
a lower bound which is the driving voltage less the threshold voltage.

3. The thin-film electroluminescent display according to claim 1, wherein the voltage limiter comprises:
a high voltage side limiter connected between the high voltage node and the common connection, and
a low voltage side limiter connected between the low voltage node and the common connection.

4. The thin-film electroluminescent display according to claim 3, wherein the high voltage side limiter comprises a series connection of a high voltage side zener diode and a high voltage side switching circuit, the high voltage side zener diode having a zener voltage which is smaller or equal to the threshold voltage, and larger or equal to the driving voltage less the threshold voltage.

5. The thin-film electroluminescent display according to claim 4, wherein the common driver is arranged to control the high voltage side switching circuit connected to the one or more undriven common electrodes to a conducting state during the driving period.

6. The thin-film electroluminescent display according to claim 4, wherein the high voltage side switching circuit comprises:
a P-channel field effect transistor having a gate node connected to a control node of the high voltage side switching circuit; or
an N-channel field effect transistor having a gate node connected to a gate driver unit, the gate driver unit connected to a control node of the high voltage side switching circuit.

7. The thin-film electroluminescent display according to claim 3, wherein the low voltage side limiter comprises a series connection of a low voltage side zener diode and a low voltage side switching circuit, the low voltage side zener diode having a zener voltage which is smaller or equal to the threshold voltage, and larger or equal to the driving voltage less the threshold voltage.

8. The thin-film electroluminescent display according to claim 7, wherein the common driver is arranged to control the low voltage side switching circuit connected to the one or more undriven common electrodes to a conducting state during the driving period.

9. The thin-film electroluminescent display according to claim 7, wherein the low voltage side switching circuit comprises an N-channel field effect transistor having a gate node connected to a control node of the low voltage side switching circuit.

10. The thin-film electroluminescent display according to claim 1, wherein at least one of the segment electrodes has a different area than the other segment electrodes.

11. The thin-film electroluminescent display according to claim 1, wherein one of the segment electrodes overlapping one common electrode has an area of overlap which is different than the areas of overlaps of one or more others of the segment electrodes overlapping the same one common electrode.

12. The thin-film electroluminescent display according to claim 1, wherein one of the segment electrodes overlapping one common electrode has an area of overlap which is less than a fraction of a combined area of overlaps of one or more others of the segment electrodes overlapping the same one common electrode, such that the fraction is equal to a value of (VH/VT)−1, where VH is the driving voltage, and VT is the threshold voltage.

13. A method for driving a thin-film electroluminescent display, the thin-film electroluminescent display comprising:
a high voltage node supplying a driving voltage;
a low voltage node supplying a low voltage;
a thin-film display element extending substantially along abase plane defining a lateral extension of the thin-film display element, the thin-film display element comprising:
a common layer comprising common electrodes;
a segment layer comprising segment electrodes, the segment electrodes arranged at least partially to laterally overlap with the common electrodes;
a luminescent layer arranged between the common layer and the segment layer, the thin-film electroluminescent display comprising:
a common driver comprising common connections, each of the common connections connected to one of the common electrodes, the method comprising:
feeding segment driving voltage signals by a segment driver to the segment electrodes during a driving period;
feeding a common driving voltage signal sequentially to a driven common electrode during the driving period through one of the common connections, the driven common electrode being one of the common electrodes;
setting one or more undriven common electrodes and the common connections connected to the one or more undriven common electrodes to a high impedance state during the driving period, the one or more undriven common electrodes being the common electrodes other than the driven common electrode;
producing visible light with the luminescent layer when a voltage difference between the common electrodes and the segment electrodes exceeds a threshold voltage; and
limiting the voltage of the one or more undriven common electrodes caused by the segment driving voltage signals during the driving period to a voltage which may vary within a limited voltage range with voltage limiters connected to each of the common connections.

14. The method for driving the thin-film electroluminescent display according to claim 13, wherein the limited voltage range has:
an upper bound which is the threshold voltage; and
a lower bound which is the driving voltage less the threshold voltage.

15. The method for driving the thin-film electroluminescent display according to claim 13, wherein the method is executed in the thin-film electroluminescent display according to claim 1.
